(19) United States
(12) Patent Application Publication
(10) Pub. No.: US 2015/0026493 A1
(43) Pub. Date: Jan. 22, 2015

(54) NONVOLATILE MEMORY DEVICE AND DEVICE SLEEP STATE CONTROL METHOD THEREOF

(71) Applicant: Samsung Electronics Co., Ltd., Suwon-Si (KR)

(72) Inventors: Kyu-Dong KIM, Yongin-si (KR); WooSeong CHEONG, Suwon-si (KR)

(21) Appl. No.: 14/331,817

(22) Filed: Jul. 15, 2014

(30) Foreign Application Priority Data
Jul. 16, 2013 (KR) 10-2013-0083589

(51) Int. Cl. G06F 1/32

(52) U.S. Cl. CPC G06F 1/3275
USPC 713/320

(57) ABSTRACT

A nonvolatile memory device includes a device interface configured to communicate with a host. The nonvolatile memory device includes a sleep controller configured to select a sleep state from among a plurality of sleep states. The sleep controller is configured to control the device interface to enter the selected sleep state. Each of the plurality of sleep states have different resume times. The resume times are a period of time taken for the nonvolatile memory device to exit an associated sleep state. In each of the plurality of sleep states, the sleep controller is configured to remove a supply of power from physical blocks of the device interface except for a physical block used for sideband signaling.

### CROSS-REFERENCE TO RELATED APPLICATIONS

A claim for priority under 35 U.S.C. §119 is made to Korean Patent Application No. 10-2013-0083589 filed Jul. 16, 2013, in the Korean Intellectual Property Office, the entire contents of which are hereby incorporated by reference.

### BACKGROUND

The inventive concepts relate to a nonvolatile memory device, and more particularly, relate to a nonvolatile memory device with a plurality of sleep states and/or a sleep state control method thereof.

In a memory system, a host and a memory device are connected through a standardized interface. In this application, the standardized interface is the protocol on a device or machine for connecting the host and the memory device, electrical requirements, and command sets.

In the memory system, the standardized interface for connecting the host and the memory device includes a variety of interfaces. Some of the standardized interfaces may support a plurality of power states. For example, a SATA interface supports a ready state PHYRDY where a device operates in an active state. Also, the SATA interface supports partial, slumber, and sleep states where a device operates in a power-saving state.

### SUMMARY

According to at least one example embodiment, a nonvolatile memory device includes a device interface and a controller. The device interface is configured to communicate with a host. The controller is configured to select a sleep state from among a plurality of sleep states, and control the device interface to enter the selected sleep state. Each of the plurality of sleep states have different resume times. Each of the resume times is a period of time taken for the nonvolatile memory device to exit an associated sleep state. In each of the plurality of sleep states, the controller is configured to remove a supply of power from physical blocks of the device interface except for a physical block used for sideband signaling.

According to at least one example embodiment, the controller is configured to select the sleep state in response to a flag provided from the host.

According to at least one example embodiment, the controller is configured to select the sleep state based on at least one of a current command and data provided from the host.

According to at least one example embodiment, the controller is configured to select the sleep state based on a time difference associated with the current command and reference times, the time difference being an amount of time between receiving a previous command and the current command from the host.

According to at least one example embodiment, the plurality of sleep states includes a first sleep state having a first resume time and a second sleep state having a second resume time longer than the first resume time, the first resume time being a period of time taken for the nonvolatile memory device to exit the first sleep state, the second resume time being a period of time taken for the nonvolatile memory device to exit the second sleep state. The controller is configured to select the first sleep state if the time difference exceeds a first reference time, and select the second sleep state if the time difference exceeds a second reference time longer than the first reference time.

According to at least one example embodiment, the current command is one of a read command and a program command.

According to at least one example embodiment, the controller is configured to select the sleep state based on an input period of the current command and a reference time.

According to at least one example embodiment, the controller is configured to select the sleep state based on an average size of data provided from the host and a reference size.

According to at least one example embodiment, the controller is configured to select the sleep state based on a desired resume time and the average size of the data.

According to at least one example embodiment, the device interface is a high speed serial interface including a physical layer.

According to at least one example embodiment, a sleep state control method of a nonvolatile memory device includes determining whether to enter a sleep state. The method includes selecting one of a plurality of sleep states, each of the plurality of sleep states having a different resume time based on an access environment, each of the resume times being a period of time taken for the nonvolatile memory device to exit an associated sleep state. The method includes entering the selected sleep state. The method includes removing a supply of power from physical blocks of the device interface except for a physical block used for sideband signaling.

According to at least one example embodiment, the determining whether to enter a sleep state determines whether to enter a sleep mode in response to a flag provided from the host.

According to at least one example embodiment, the access environment is based on a time difference associated with a current command and reference times, the time difference being an amount of time between receiving a previous command and the current command from the host.

According to at least one example embodiment, the access environment is based on an average size of data provided from the host.

According to at least one example embodiment, the method includes determining the access environment in response to a flag provided from the host, the flag being generated based on an operation state of firmware or software driven on the host.

According to at least one example embodiment, a nonvolatile memory device includes an interface configured to communicate with a host. The interface includes a plurality of blocks, at least one of the blocks being configured to receive a sleep command from the host using sideband signaling. The interface includes a controller configured to select a sleep state from among a plurality of sleep states in response to the sleep command. The controller is configured to control the nonvolatile memory device to enter the selected sleep state. The controller is configured to maintain a supply of power to the at least one block during the selected sleep state.

According to at least one example embodiment, the controller is configured to select the sleep state in response to a flag from the host.

According to at least one example embodiment, the controller is configured to remove a supply of power from remaining blocks of the interface during the selected sleep state.

According to at least one example embodiment, the controller is configured to select the sleep state based on a time difference, the time difference being an amount of time between receiving commands from the host.

According to at least one example embodiment, the plurality of sleep states includes a first sleep state having a first resume time and a second sleep state having a second resume time longer than the first resume time, the first resume time being a period of time taken for the nonvolatile memory device to exit the first sleep state, the second resume time being a period of time taken for the nonvolatile memory device to exit the second sleep state. The controller is configured to select the first sleep state if the time difference exceeds a first reference time, and select the second sleep state if the time difference exceeds a second reference time longer than the first reference time.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a memory system 10 including a nonvolatile memory device 100 according to at least one example embodiment of the inventive concepts;

FIG. 2 is a graph showing a relation between average power consumption at a sleep state and a resume time;

FIG. 3 is a flow chart schematically illustrating a sleep state control method according to at least one example embodiment of the inventive concepts;

FIG. 4 is a block diagram schematically illustrating a nonvolatile memory device applied to a memory system including a SATA interface, according to at least one example embodiment of the inventive concepts;

FIG. 5 is a diagram for describing resume times according to sleep states;

FIG. 6 is a flow chart showing a sleep state control method according to at least one example embodiment of the inventive concepts;

FIG. 7 is a block diagram schematically illustrating a handheld electronic system including a nonvolatile memory device according to at least one example embodiment of the inventive concepts;

FIG. 8 is a block diagram schematically illustrating a memory card to which a nonvolatile memory device according to at least one example embodiment of the inventive concepts is applied; and

FIG. 9 is a diagram schematically illustrating various systems to which the memory card in FIG. 8 is applied.

### DETAILED DESCRIPTION OF EXAMPLE EMBODIMENTS

Example embodiments will be described in detail with reference to the accompanying drawings. The inventive concepts, however, may be embodied in various different forms, and should not be construed as being limited only to the illustrated example embodiments. Rather, these example embodiments are provided so that this disclosure will be thorough and complete, and will fully convey the concept of the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which these inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

FIG. 1 is a block diagram schematically illustrating a memory system 10 including a nonvolatile memory device 100 according to at least one example embodiment of the inventive concepts. Referring to FIG. 1, a memory system 10 includes a nonvolatile memory device 100 and a host 101.

The host 101 controls the nonvolatile memory device 100. The host 101 may be a portable electronic device such as PMP, PDA, smart phone, etc. or an electronic device such as a computer, HDTV, etc.

The nonvolatile memory device 100 stores data in response to a control (e.g., control signal) of the host 101. Data stored in the nonvolatile memory device 100 may be retained even when a power is interrupted. The nonvolatile memory device 100 may be, for example, a solid state drive. However, the inventive concepts are not limited thereto.

The host 101 is connected to the nonvolatile memory device 100 through a host interface 102. The nonvolatile memory device 100 is connected to the host 101 through a device interface 110.

The host interface 102 and the device interface 110 may be high speed serial interfaces that include a physical (PHY) layer to perform a SERDES (Serializer-deserializer) operation. The host interface 102 and the device interface 110 may have relatively rapid data transfer rates. For example, the host interface 102 and the device interface 110 may be one of a variety of standardized interfaces such as SATA (serial ATA), PCI-E (PCI express), UFS (Universal Flash Storage), SAS (serial attached SCSI), USB (Universal Serial Bus) 3.0, FC (Fibre Channel), UHS-II, Light-peak, etc. However, the inventive concepts are not limited thereto.

To reduce power consumption of the memory system 10, the nonvolatile memory device 100 enters a sleep state. The sleep state may be a low-power state occurring under a particular condition.

During the sleep state, data transactions cease between the host 101 and the nonvolatile memory device 100. In particular, the nonvolatile memory device 100 powers a block receiving a sleep command signal. The block may be from among a plurality of blocks of the device interface 101. While the nonvolatile memory device 100 is in the sleep state, the host 101 does not power the host interface 102.

The sleep command signal is a signal directing the memory system 10 to enter in to a sleep state release from the sleep state. The sleep command signal is provided using sideband signaling. Sideband signaling may refer to a method of sending signals between the host 101 and the nonvolatile memory device 100 at a frequency other than a carrier frequency for normal command signals (e.g., read, program, etc.) and data signals. For example, in the sleep state, the nonvolatile memory device 100 enters a state in which an OOB (Out Of Band) signal is received, from the sleep state. The nonvolatile memory device 100 enters a ready state in response to the input OOB signal.

The nonvolatile memory device 100 according to at least one inventive concept supports a plurality of sleep states. The average power consumption of the nonvolatile memory device 100 may be variable according to the sleep states. According to at least one example embodiment, a resume time is varied according to average power consumption of each sleep state. The resume time may correspond to a time taken to change from a sleep state to a ready state.

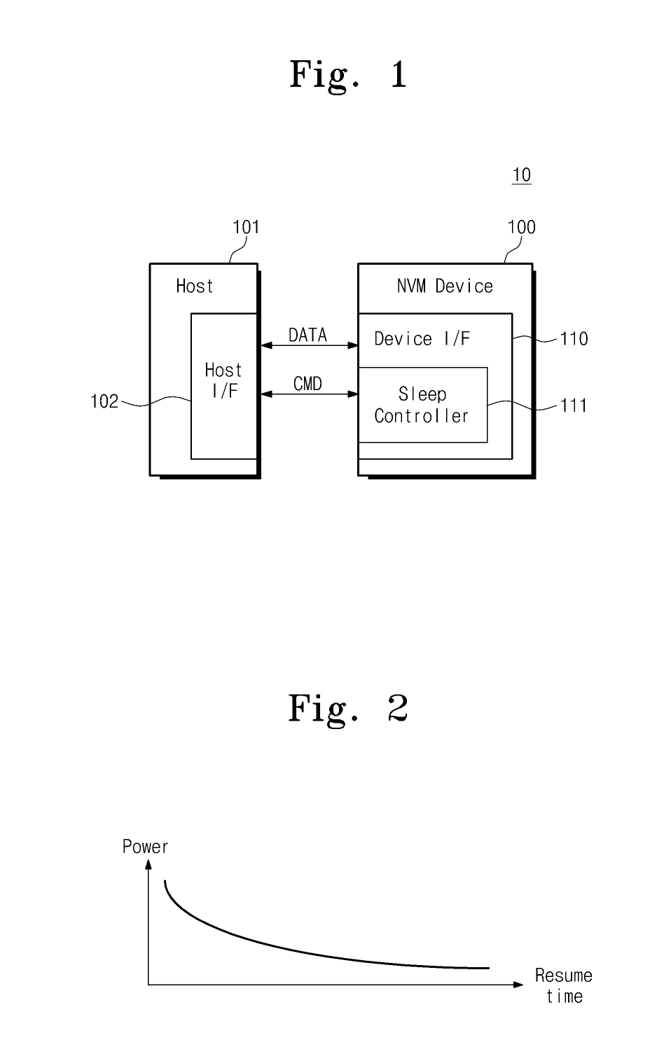

FIG. 2 is a graph showing a relation between average power consumption in a sleep state and a resume time. Referring to FIG. 2, a trade-off exists between an average power consumed in a sleep state and a resume time.

To enter the sleep state, a host interface 102 (refer to FIG. 1) of a host 101 (refer to FIG. 1) is turned off. Also in the sleep state, physical blocks (constituting a PHY layer) included in a device interface 110 (refer to FIG. 1) of a nonvolatile memory device 100 (refer to FIG. 1) are turned off.

The greater the number of physical blocks turned off, the less average power consumption of a memory system 10. However, as the number of physical blocks turned off increases, a resume time taken for the nonvolatile memory device 100 to operate normally may increase. On the other hand, the fewer the number of physical blocks turned off, the more average power consumption of the memory system 10. However, as the number of physical blocks turned off decreases, a resume time taken for the nonvolatile memory device 100 to operate normally may be decrease.

Referring to FIG. 1, the nonvolatile memory device 100 of the inventive concepts operates in a sleep state that is selected from a plurality of sleep states based on an access condition. For the sleep mode selection operation, the nonvolatile memory device 100 operates with a resume time and a power consumption suitable for a characteristic of the memory system 10.

Below, it is assumed that the nonvolatile memory device 100 supports a first sleep state having a first resume time and a second sleep state having a second resume time longer than the first resume time. The number of sleep states supported by the nonvolatile memory device 100 is exemplary, however, and the inventive concepts are not limited to the first and second sleep states.

The host 101 and the nonvolatile memory device 100 exchange data through interfaces 102 and 110. The host 101 provides the nonvolatile memory device 100 with a command CMD for controlling the nonvolatile memory device 100 through the interfaces 102 and 110. The command CMD, for example, may include a read command, a program command, a sleep command signal, etc.

The nonvolatile memory device 100 includes a sleep controller 111 for controlling a sleep state. The sleep controller 111 selects one of a plurality of sleep states based on an access condition/environment of the nonvolatile memory device 100. The sleep controller 111 determines the access condition/environment of the nonvolatile memory device 100 using data and a command CMD provided from the host 101.

In at least one exemplary embodiment, the sleep controller 111 selects a sleep state by comparing an absence time of a command CMD with reference times. For example, if the host 101 does not provide a read/program command signal to the nonvolatile memory device 100 within a first reference time, the sleep controller 111 controls the nonvolatile memory device 100 to enter the first sleep state. Also, if the host 101 does not provide a read/program command signal to the nonvolatile memory device 100 within a second reference time longer than the first reference time, the sleep controller 111 controls the nonvolatile memory device 100 to enter the second sleep state.

In at least one other exemplary embodiment, the sleep controller 111 selects a sleep state based on an input period of a particular command CMD. The input period of a command CMD may correspond to a duration of the signal carrying the command CMD. For example, the sleep controller 111 selects a sleep state by comparing an average input period of a particular command with a reference time (where the average input period is the mean of a plurality of input periods). For example, if an input period of a sleep command signal is greater than a first reference time, the sleep controller 111 controls the nonvolatile memory device 100 to enter the first sleep state. Further, if an input period of a sleep command signal is over a second reference time longer than the first reference time, the sleep controller 111 controls the nonvolatile memory device 100 to enter the second sleep state.

In still at least one other exemplary embodiment, the sleep controller 111 selects a sleep state based on to the size of data transferred. For example, if an average size of data transferred is smaller than a first reference size, the sleep controller 111 controls the nonvolatile memory device 100 to enter the first sleep state. Further, if an average size of data transferred is smaller than a second reference size, the sleep controller 111 controls the nonvolatile memory device 100 to enter the second sleep state. The second reference size may be smaller than the first reference size.

At least one example embodiment, the sleep controller 111 determines an access condition/environment of the nonvolatile memory device 100 using a flag provided from the host 101. In response to the input flag, the sleep controller 111 selects a sleep state for the nonvolatile memory device 100. However, the inventive concepts are not limited thereto. A sleep state selection method of the inventive concepts is not limited to one of the above-described methods.

As described above, the nonvolatile memory device 100 operates at a sleep state that is selected from a plurality of sleep states based on an environment/condition of the memory system 10. According to the sleep mode selection operation, the nonvolatile memory device 100 operates with a resume time and power consumption suitable for a characteristic of the memory system 10.

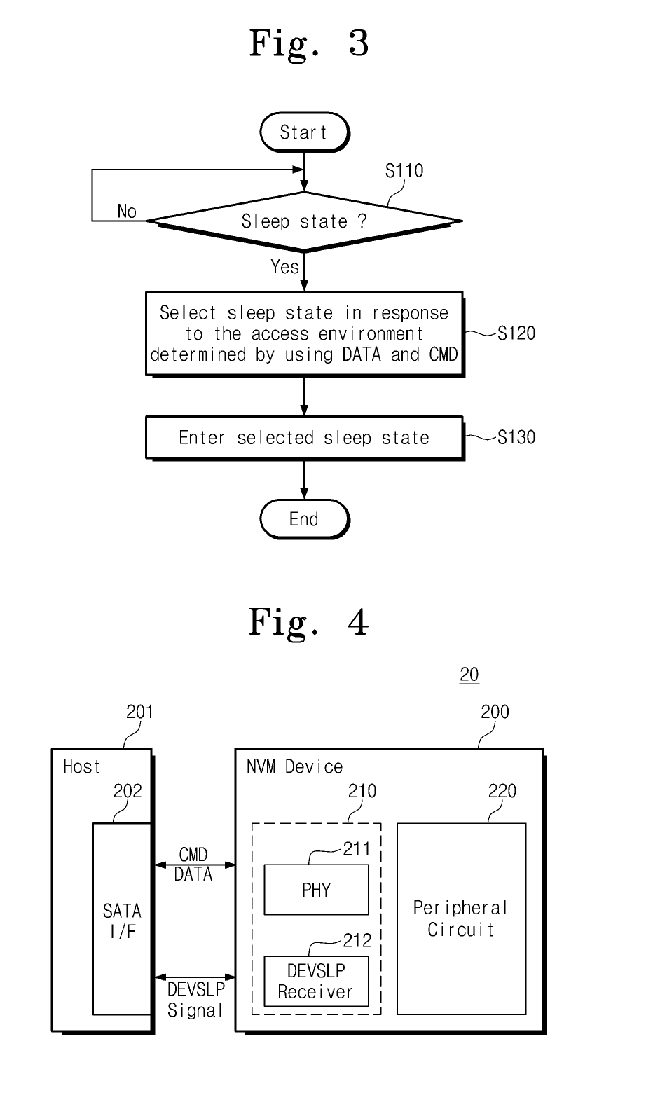

FIG. 3 is a flow chart schematically illustrating a sleep state control method according to at least one example embodiment of the inventive concepts. A nonvolatile memory device 100 (refer to FIG. 1) supports a plurality of sleep states according to a sleep state control method show in FIG. 3. The nonvolatile memory device 100 operates in a sleep state, selected based on an access environment, from among a plurality of sleep states. According to a sleep mode selection operation, the nonvolatile memory device 100 operates with a resume time and power consumption suitable for a characteristic of a memory system 10.

In step S110, whether to enter a sleep mode is determined. For example, the nonvolatile memory device 100 determines whether to enter a sleep mode using a flag provided from a host 101 (refer to FIG. 1). Alternatively, the nonvolatile memory device 100 actively determines whether to enter a sleep mode using a sleep controller 111 (refer to FIG. 1).

In step S120, the sleep controller 11 selects one of the sleep states based on the access environment. The access environment may be determined using data and/or a command provided from the host 101. For example, the access environment is determined by comparing an absence time of a particular command with reference times. Alternatively or additionally, the access environment is determined based on an input period of a particular command and/or the size of data transferred between host 101 and nonvolatile memory device 100. Further still, the access environment may be determined using a flag provided from the host 101.

In step S130, the nonvolatile memory device 100 enters the selected sleep state under a control of sleep controller 111.

The nonvolatile memory device 100 operates in a sleep state, selected based on an access environment, from among a plurality of sleep states. According to the above described sleep mode selection operation, the nonvolatile memory device 100 operates with a resume time and power consumption suitable for a characteristic of a memory system 10.

FIG. 4 is a block diagram schematically illustrating a nonvolatile memory device applied to a memory system including a SATA interface, according to at least one example embodiment of the inventive concepts. Referring to FIG. 4, a memory system 20 includes a host 201 and a nonvolatile memory device 200. The nonvolatile memory device 200 includes a device interface 210 for communicating with the host 201 and a peripheral circuit 220 formed of other circuits.

The device interface 210 of the nonvolatile memory device 200 supports a ready state, a partial state, a slumber state, and a plurality of sleep states.

During the ready state, the nonvolatile memory device 200 operates in an active state. Physical blocks constituting a physical (PHY) layer of the device interface 210 are activated in the ready state.

During the partial state, the nonvolatile memory device 200 operates in a power-saving state. Data transactions between the nonvolatile memory device 200 and the host 201 cease during the partial state. During the partial state, a power is not supplied to physical blocks of a PHY layer associated with data transmission and reception.

During the slumber state, the nonvolatile memory device 200 operates in a power-saving state. Data transactions between the nonvolatile memory device 200 and the host 201 cease during the slumber state. In addition, during the slumber state, a signal exchange ceases between the nonvolatile memory device 200 and the host 201 except for Out of Band (OOB) signaling. OOB signaling may refer to a method of sending signals between the host 201 and the nonvolatile memory device 200 at a frequency other than a carrier frequency for normal command signals (e.g., read, program, etc.) and data signals. During the slumber state, a power is not supplied to remaining physical blocks of the physical blocks of the device interface 210 except for a physical block receiving an OOB signal.

During the sleep states, the nonvolatile memory device 200 operates at a power-saving state. An average power consumed by the nonvolatile memory device 200 may be different for each sleep state. Data transactions between the nonvolatile memory device 200 and the host 201 cease during the sleep state. In addition, during the sleep states, a signal exchange ceases between the nonvolatile memory device 200 and the host 201 except for OOB signaling.

When entering each sleep state, the nonvolatile memory device 200 powers a Device Sleep (DEVSLP) receiver 213 and does not power the remaining blocks of the device interface. The DEVSLP receiver 213 is a block that transmits and receives DEVSLP signals transferred through the sideband signaling. Power consumption of the DEVSLP receiver 213 is less than that of a block for receiving an OOB signal. A DEVSLP signal is a signal that controls entering into a sleep state or releasing from a sleep state.

The nonvolatile memory device 200 of the inventive concepts operates in a sleep state, selected based on an access environment, from among a plurality of sleep states. According to a sleep mode selection operation, the nonvolatile memory device 200 operates with a resume time and power consumption suitable for a characteristic of a memory system 20. This will be more fully described with reference to accompanying drawings.

The host 201 controls the nonvolatile memory device 200. The host 201 may be a portable electronic device such as PMP, PDA, smart phone, etc. or an electronic device such as a computer, HDTV, etc.

The nonvolatile memory device 200 stores data in response to a control of the host 201. The nonvolatile memory device 200, for example, a solid state drive. However, the inventive concepts are not limited thereto.

The host 201 is connected to the nonvolatile memory device 200 through a host interface 202. The nonvolatile memory device 200 is connected to the host 201 through a device interface 210. In at least one exemplary embodiment, the host interface 202 and the device interface 210 may be a serial ATA standardized interface.

The host 201 and the nonvolatile memory device 200 exchange data through interfaces 202 and 210. The host 201 provides the nonvolatile memory device 200 with a command CMD for controlling the nonvolatile memory device 200 through the interfaces 202 and 210. The command CMD, for example, may include a read command, a program command, a sleep command signal, etc.

The host 201 and the nonvolatile memory device 200 activate or deactivate the DEVSLP signal through the interfaces 202 and 210. The DEVSLP signal is transmitted and received using sideband signaling.

In the event that the nonvolatile memory device 200 receives an activated DEVSLP signal from the host 201 or satisfies a predetermined (or alternatively, desired) condition, the nonvolatile memory device 200 enters a sleep state. The device interface 210 of the nonvolatile memory device 200 includes a physical (PHY) layer 211 and a DEVSLP receiver 212. A power is not supplied to the PHY layer 211 during the sleep state.

Below, it is assumed that the nonvolatile memory device 200 supports a first sleep state having a first resume time and a second sleep state having a second resume time longer than the first resume time. The number of sleep states supported by the nonvolatile memory device 100 is exemplary, and the inventive concepts are not limited to the first and second sleep states.

In an initial state, the nonvolatile memory device 200 is set not to use a plurality of sleep states. The host 201 sets the nonvolatile memory device 200 using a flag so as to use a plurality of sleep states.

The nonvolatile memory device 200 has a plurality of control modes for entering a selected a sleep state. The control modes of the nonvolatile memory device 200 may include an auto control mode, a host control mode, and a mix control mode.

In the auto control mode, the nonvolatile memory device 200 selects one of the sleep states based on an access environment/condition of the nonvolatile memory device 200. The nonvolatile memory device 200 determines the access environment using data and/or a command CMD provided from the host 201.

In the host control mode, the nonvolatile memory device 200 selects a sleep state in response to a flag provided from the host 201. The host 201 determines an access environment of the nonvolatile memory device 200 using firmware or software used to drive the host. Alternatively, the host 201 determines an access environment of the nonvolatile memory device 200 using a command CMD and/or data provided to the nonvolatile memory device 200. The host 201 generates a flag based on the determined access environment.

In the mix control mode, the nonvolatile memory device 200 selects one of sleep states in response to a flag provided from the host 201 or the nonvolatile memory device 200 actively selects one of the sleep states.

In the auto control mode and the mix control mode, the nonvolatile memory device 200 selects a sleep state by comparing an absence time of a command CMD with reference times. For example, if the host 201 does not provide a read/program command signal to the nonvolatile memory device 200 within a first reference time, the nonvolatile memory device 200 enters the first sleep state without intervention of the host 201. Further, if of the host 201 does not provide a read/program command signal to the nonvolatile memory device 200 within a second reference time longer than the first reference time, the nonvolatile memory device 200 enters the second sleep state without intervention of the host 201.

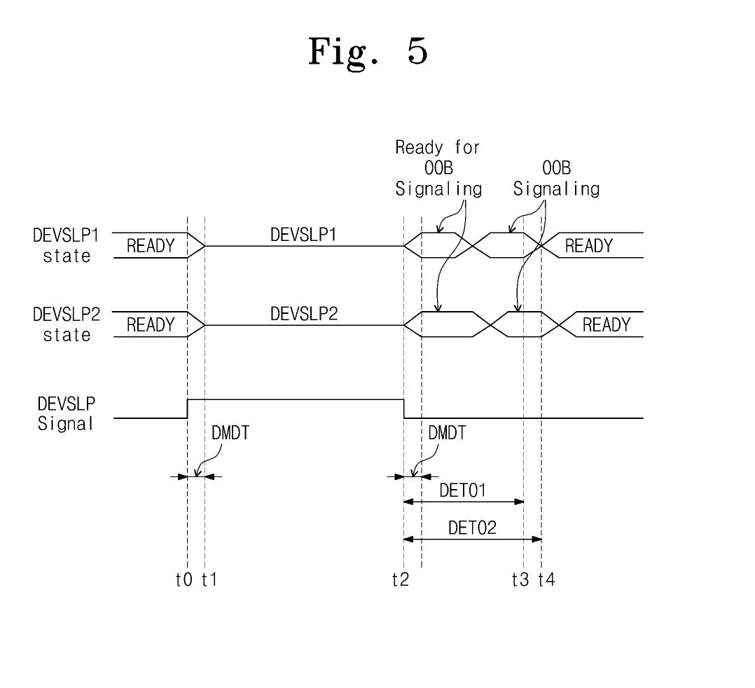

In at least one other exemplary embodiment, the nonvolatile memory device 200 selects a sleep state in response to an input period of the DEVSLP. The input period of the DEVSLP signal may correspond to a duration of the signal (in FIG. 5, the input period of the DEVSLP may be from time t0 to time t2). The nonvolatile memory device 200 selects a sleep state based on an input period or an average input period of the DEVSLP signal and a reference time (where the average input period is a mean of a plurality of input periods). For example, if an input period of the DEVSLP signal is greater than a first reference time, the nonvolatile memory device 200 enters the first sleep state without intervention of the host 201. Further, if an input period of the DEVSLP signal is greater than a second reference time longer than the first reference time, the nonvolatile memory device 200 enters the second sleep state without intervention of the host 201.

In still at least one other exemplary embodiment, the nonvolatile memory device 200 selects a sleep state based on the size of data transferred between the host 201 and the nonvolatile memory device 200. For example, if an average size of data transferred from the host 201 is smaller than a first reference size, the nonvolatile memory device 200 enters the first sleep state without intervention of the host 201. Further, if an average size of data transferred from the host 201 is smaller than a second reference size that is smaller than the first reference size, the nonvolatile memory device 200 enters the second sleep state without intervention of the host 201.

The nonvolatile memory device 200 operates in a sleep state, selected based on an access environment of the memory system 20, from among a plurality of sleep states. According to a sleep mode selection operation, the nonvolatile memory device 200 operates with a resume time and power consumption suitable for a characteristic of a memory system 20.

FIG. 5 is a diagram for describing resume times according to sleep states. In FIG. 5, a first sleep state and a second sleep state are shown. Also, in FIG. 5, a nonvolatile memory device 200 (refer to FIG. 4) is in a ready state before entering into a sleep state. However, the inventive concepts are not limited thereto. For example, the nonvolatile memory device 200 may be at a partial state or at a slumber state before entering into a sleep state.

At t0, a DEVSLP signal is activated. The DEVSLP signal is provided from a host 201 a nonvolatile memory device 200 (refer to FIG. 4) through sideband signaling.

At time t1, after a predetermined (or alternatively, desired) time DMDT (DEVSLP Minimum Detection Time) elapses from t0, the nonvolatile memory device 200 enters a first or second sleep state. In the first and second sleep states, a physical block 211 of a device interface 210 in the nonvolatile memory device 200 is turned off.

At time t2, the DEVSLP signal is deactivated. The DEVSLP signal is provided from the host 201 to the nonvolatile memory device 200 through the sideband signaling.

If deactivation of the DEVSLP is recognized during a predetermined (or alternatively, desired) time DMDT from time t2, the nonvolatile memory device 200 turns on physical blocks for OOB signaling. The OOB signaling is signaling that includes an initial connection operation (e.g., a power on sequence operation), a return operation from a power-saving mode, etc. The OOB signaling uses a signal distinguished by the number of burst signals and an interval of burst signals, not a signal having transfer speeds of 1.5 Gbps, 3.0 Gbps, 6.0 Gbps, etc.

At time t3, preparation for OOB signaling of the nonvolatile memory device 200 being at a first sleep state ends. At time t4, preparation for OOB signaling of the nonvolatile memory device 200 being at a second sleep state ends. The nonvolatile memory device 200 enters the ready state using the OOB signaling.

As shown in FIG. 5, in the nonvolatile memory device 200, a resume time DETO (Devsleep Exit TimeOut) is variable according to the first and second sleep states. The resume time may be a time between a first time point when the DEVSLP is deactivated and a second time point when preparation for OOB signaling is completed.

The nonvolatile memory device 200 in the first sleep state may have a relatively fast resume time. The nonvolatile memory device 200 in the second sleep mode may operate with relatively less power compared to the first sleep mode. However, a resume time corresponding to the second sleep mode may be longer than the resume time of the first sleep mode. According to a sleep state selection operation, the nonvolatile memory device 200 operates with a resume time and power consumption suitable for a characteristic of a memory system 10.

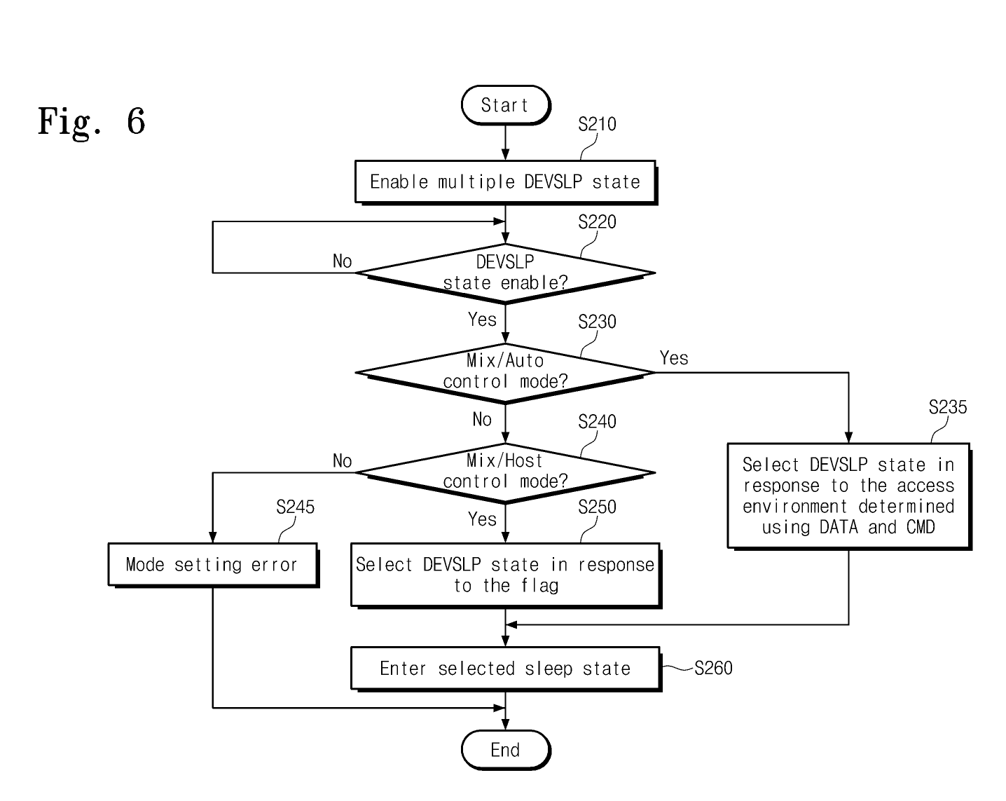

FIG. 6 is a flow chart showing a sleep state control method according to at least one example embodiment of the inventive concepts. A nonvolatile memory device 400 (refer to FIG. 2) supports a plurality of sleep states according to a sleep state control method show in FIG. 6. The nonvolatile memory device 200 operates in a sleep state, selected based on an access environment, from among a plurality of sleep states. According to a sleep state selection operation, the nonvolatile memory device 200 operates with a resume time and power consumption suitable for a characteristic of a memory system.

In step S210, a nonvolatile memory device 200 is set to use a plurality of sleep states. For example, a host 201 sets the nonvolatile memory device using a flag to enable the plurality of sleep states.

In step S20, the nonvolatile memory device 200 determines whether to enter a sleep mode. For example, the nonvolatile memory device 200 determines whether to enter a sleep mode using a flag provided from the host. Alternatively, the nonvolatile memory device 200 actively determines whether to enter a sleep mode without intervention from the host 201.

In step S230, the nonvolatile memory device 200 determines whether a control mode is a mix control mode or an auto control mode. The control mode may be associated with a plurality of modes for selecting a sleep state and entering the selected sleep state. In the auto control mode, the nonvolatile memory device actively selects one of the sleep states based on an access environment. In the mix control mode, the nonvolatile memory device selects one of the sleep states in response to a flag provided from the host or by actively selecting one of the sleep states.

If the nonvolatile memory device 200 determines that the control mode is the mix control mode or the auto control mode, in step S235, one of the sleep states is selected according to the access environment. The access environment is determined based on data and/or a command provided from the host. For example, the access environment is determined by comparing an absence time of a particular command with reference times. Further, the access environment is determined based on an input period of a particular command or based on the size of data transferred. Further still, the access environment is determined using a flag provided from the host 201.

In step S240, the nonvolatile memory device 200 determines whether the control mode is the mix control mode or a host control mode. If the nonvolatile memory device 200 determines that the control mode is not the mix control mode or the host control mode, in step S245, the nonvolatile memory device 200 determines a mode setting error.

If the nonvolatile memory device 200 determines that the control mode is the mix control mode or the host control mode, in step S250, the nonvolatile memory device 200 selects a sleep state in response to a flag provided from the host 201. The host 201 may determine the access environment of the nonvolatile memory device based on firmware and software driving the host 201. Further, the host 201 may determine the access environment of the nonvolatile memory device using data and a command CMD provided to the nonvolatile memory device. The host generates the flag based on the determined access environment.

In step S260, the nonvolatile memory device 200 enters the selected sleep state.

The nonvolatile memory device 200 operates at a sleep state, selected based on an access environment, from among a plurality of sleep states under the control of the host 201 or automatically without intervention of the host 201. According to a sleep state selection operation, the nonvolatile memory device operates with a resume time and power consumption suitable for a characteristic of a memory system.

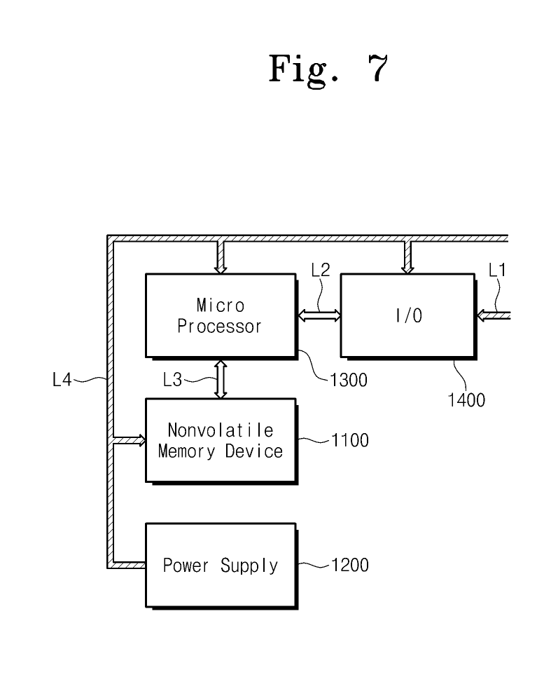

FIG. 7 is a block diagram schematically illustrating a handheld electronic system including a nonvolatile memory device according to at least one example embodiment of the inventive concepts. A nonvolatile memory device 1100 operates at a sleep state, selected based on an access environment, from among a plurality of sleep states. According to a sleep state selection operation, the nonvolatile memory device 1100 operates with a resume time and power consumption suitable for a characteristic of a handheld electronic system 1000.

The nonvolatile memory device 1100 connected to a microprocessor 1300 through a bus line L3 is used as a storage device of the handheld electronic system 1000. A power supply 1200 supplies a power to the microprocessor 1300, an input/output device 1400, and the nonvolatile memory device 1100 through a power line L4. Here, the microprocessor 1300 and the input/output device 1400 may constitute a memory controller for controlling the nonvolatile memory device 1100.

In the event that input data is provided to the input/output device 1400 through a line L1, the microprocessor 1300 receives and processes data through a line L2 to output the processed result to the nonvolatile memory device 1100 through the bus line L3. The nonvolatile memory device 1100 stores data provided through the bus line L3 in memory cells. Data stored in memory cells is read by the microprocessor 1300, and the read data is output to an external device through the input/output device 1400.

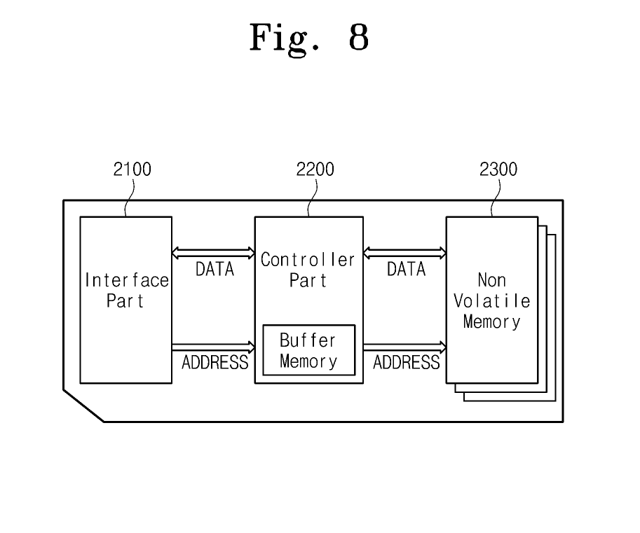

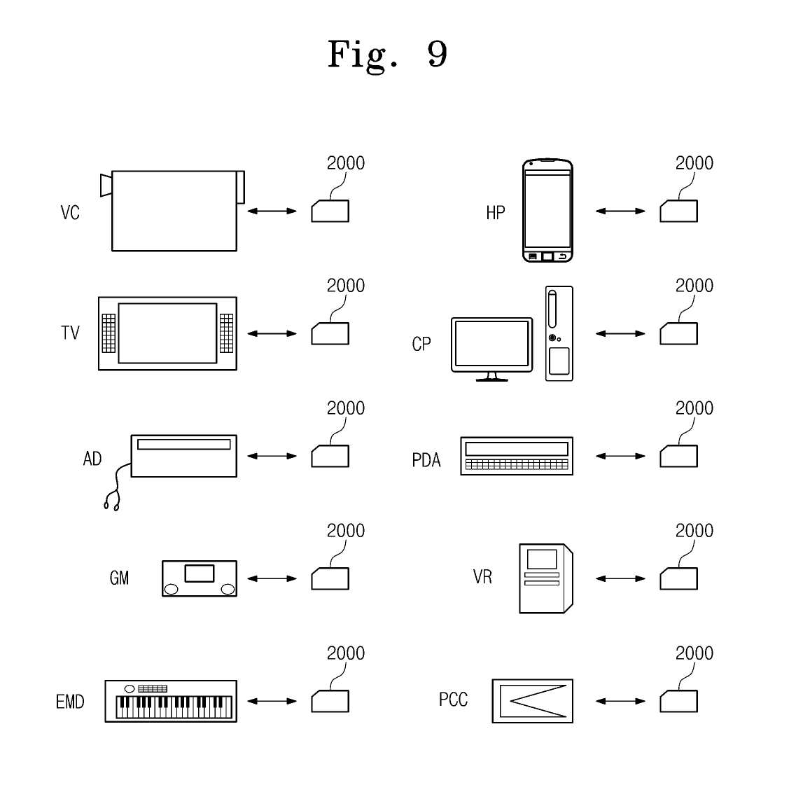

FIG. 8 is a block diagram schematically illustrating a memory card to which a nonvolatile memory device according to at least one example embodiment of the inventive concepts is applied. A memory card 2000, for example, may be an MMC card, an SD card, a multiuse card, a micro-SD card, a memory stick, a compact SD card, an ID card, a PCMCIA card, an SSD card, a chip-card, a smartcard, an USB card, etc.

Referring to FIG. 8, the memory card 2000 includes an interface circuit 2100 for interfacing with an external device, a controller 2200 including a buffer memory and controlling an operation of the memory card 2000, and at least one nonvolatile memory device 2300 according to an example embodiment of the inventive concepts. The controller 2200 is a processor which is configured to control write and read operations of the nonvolatile memory device 2300. The controller 2200 is connected to the nonvolatile memory device 2300 and the interface circuit 2100 through a data bus and an address bus.

The nonvolatile memory device 2300 operates in a sleep state, selected based on an environment of the memory card 2000, from among a plurality of sleep states. According to a sleep state selection operation, the nonvolatile memory device 2300 operates with a resume time and power consumption suitable for a characteristic of a memory card 2000.

FIG. 9 is a diagram schematically illustrating various systems to which a memory card in FIG. 8 is applied. Referring to FIG. 9, a memory card 2000 may be applied to a video camera VC, a television TV, an audio device AD, a game machine GM, an electronic music device EMD, a cellular phone HP, a computer CP, a Personal Digital Assistant PDA, a voice recorder VR, a PC card PCC, etc.

A nonvolatile memory device according to at least one example embodiment of the inventive concepts may be packed using various types of packages. For example, a non-volatile memory device may be packed using packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The inventive concepts may be modified or changed variously. For example, a detailed structure of a device interface may be changed or modified variously according to environment and use. While the inventive concepts have been described with reference to exemplary embodiments, it will be apparent to those skilled in the art that various changes and modifications may be made without departing from the spirit and scope of the present invention. Therefore, it should be understood that the above example embodiments are not limiting, but illustrative.

What is claimed is:

1. A nonvolatile memory device, comprising:
a device interface configured to communicate with a host; and
a controller configured to select a sleep state from among a plurality of sleep states, and control the device interface to enter the selected sleep state, each of the plurality of sleep states having different resume times, each of the resume times being a period of time taken for the nonvolatile memory device to exit an associated sleep state,
wherein, in each of the plurality of sleep states, the controller is configured to remove a supply of power from physical blocks of the device interface except for a physical block used for sideband signaling.

2. The nonvolatile memory device of claim 1, wherein the controller is configured to select the sleep state in response to a flag provided from the host.

3. The nonvolatile memory device of claim 1, wherein the controller is configured to select the sleep state based on at least one of a current command and data provided from the host.

4. The nonvolatile memory device of claim 3, wherein the controller is configured to select the sleep state based on a time difference associated with the current command and reference times, the time difference being an amount of time between receiving a previous command and the current command from the host.

5. The nonvolatile memory device of claim 4, wherein the plurality of sleep states includes a first sleep state having a first resume time and a second sleep state having a second resume time longer than the first resume time, the first resume time being a period of time taken for the nonvolatile memory device to exit the first sleep state, the second resume time being a period of time taken for the nonvolatile memory device to exit the second sleep state, and
wherein the controller is configured to select the first sleep state if the time difference exceeds a first reference time, and select the second sleep state if the time difference exceeds a second reference time longer than the first reference time.

6. The nonvolatile memory device of claim 5, wherein the current command is one of a read command and a program command.

7. The nonvolatile memory device of claim 3, wherein the controller is configured to select the sleep state based on an input period of the current command and a reference time.

8. The nonvolatile memory device of claim 3, wherein the controller is configured to select the sleep state based on an average size of data provided from the host and a reference size.

9. The nonvolatile memory device of claim 8, wherein the controller is configured to select the sleep state based on a desired resume time and the average size of the data.

10. The nonvolatile memory device of claim 1, wherein the device interface is a high speed serial interface including a physical layer.

11. A sleep state control method of a nonvolatile memory device, the nonvolatile memory device including a device interface that is configured to communicate with a host, the method comprising:
determining whether to enter a sleep state;
selecting one of a plurality of sleep states, each of the plurality of sleep states having a different resume time based on an access environment, each of the resume times being a period of time taken for the nonvolatile memory device to exit an associated sleep state;
entering the selected sleep state; and
removing a supply of power from physical blocks of the device interface except for a physical block used for sideband signaling.

12. The sleep state control method of claim 11, wherein the determining whether to enter a sleep state determines whether to enter a sleep mode in response to a flag provided from the host.

13. The sleep state control method of claim 11, wherein the access environment is based on a time difference associated with a current command and reference times, the time difference being an amount of time between receiving a previous command and the current command from the host.

14. The sleep state control method of claim 11, wherein the access environment is based on an average size of data provided from the host.

15. The sleep state control method of claim 11, further comprising:
determining the access environment in response to a flag provided from the host, the flag being generated based on an operation state of firmware or software driven on the host.

16. A nonvolatile memory device, comprising:
an interface configured to communicate with a host, the interface including,
a plurality of blocks, at least one of the blocks being configured to receive a sleep command from the host using sideband signaling, and
a controller configured to,
select a sleep state from among a plurality of sleep states in response to the sleep command,
control the nonvolatile memory device to enter the selected sleep state, and
maintain a supply of power to the at least one block during the selected sleep state.

17. The nonvolatile memory device of claim 16, wherein the controller is configured to select the sleep state in response to a flag from the host.

18. The nonvolatile memory device of claim 16, wherein the controller is configured to remove a supply of power from remaining blocks of the interface during the selected sleep state.

19. The nonvolatile memory device of claim 16, wherein the controller is configured to select the sleep state based on a time difference, the time difference being an amount of time between receiving commands from the host.

20. The nonvolatile memory device of claim 19, wherein,
the plurality of sleep states includes a first sleep state having a first resume time and a second sleep state having a second resume time longer than the first resume time, the first resume time being a period of time taken for the nonvolatile memory device to exit the first sleep state, the second resume time being a period of time taken for the nonvolatile memory device to exit the second sleep state, and
the controller is configured to select the first sleep state if the time difference exceeds a first reference time, and select the second sleep state if the time difference exceeds a second reference time longer than the first reference time.
